(19) United States
(12) Patent Application Publication
(10) Pub. No.: US 2024/0324742 A1
(43) Pub. Date: Oct. 3, 2024

(54) CASE AND MOUNT FOR MOBILE DEVICE

(71) Applicant: Mous Products Ltd., London (GB)

(72) Inventors: Simon HOLROYD, London (GB); Nicholas James ATHERTON, London (GB); Daniel Richard PLATT, London (GB); Felix John William Church CROWTHER, London (GB); Jack David Montgomery FREETHY, London (GB); Daniel Thomas DARVILL, London (GB); Tobias Cedric LANE, London (GB)

(21) Appl. No.: 18/737,383

(22) Filed: Jun. 7, 2024

Related U.S. Application Data
(63) Continuation of application No. PCT/EP2022/085050, filed on Dec. 8, 2022.

(30) Foreign Application Priority Data
Dec. 10, 2021 (GB) 2117873.6

(51) Int. Cl. A45C 11/00; A45F 5/02

(52) U.S. Cl. CPC A45C 11/00; A45F 5/02; A45C 2011/002; A45F 2200/0516

(57) ABSTRACT

There is provided a mount and a case for attaching a mobile device to a further object. The mount comprises first and second coupling members and a body having a front face between the coupling members and that faces the case when the mount is attached to the case. The first and second coupling members define an undercut, for receiving part of the case. The case has an attachment for attaching the case to the mobile device, a cover for covering part of the mobile device, first and second openings in the cover, and first and second overhangs that define undercuts in the cover for mating with corresponding respective overhangs of the mount.

### CROSS-REFERENCE TO RELATED APPLICATIONS

This application is a continuation under 35 U.S.C. § 120 of International Application No. PCT/EP2022/085050, filed Dec. 8, 2022 which claims priority to United Kingdom Application No. GB 2117873.6 filed Dec. 10, 2021, under 35 U.S.C. § 119 (a). Each of the above-referenced patent applications is incorporated by reference in its entirety.

### TECHNICAL FIELD

The present invention relates to cases and mounts for attaching mobile devices to other objects.

### BACKGROUND

As mobile devices, such as mobile phones (also known as “cell phones”), become more powerful and sophisticated, the number of potential uses for them increases. Users now regularly use mobile devices to film themselves or to track and monitor their performance and progress in real time while doing sporting activities. The conventional ways of carrying a mobile device, i.e. in a hand or in a pocket, may not be suitable for such activities, particularly when the mobile device is being used for motion-sensitive activities such as filming or when there is a possibility that the device may fall or slip out of the hand or pocket of the user.

It is therefore useful to mount the mobile device to another object to provide stabilisation and to prevent the mobile device from falling away during such activities. Conventional mounts for mobile devices, used in settings such as cars or within the home, are typically not secure enough to prevent the mobile device from disconnecting from the mount during use. As a result, some ‘action mounts’ that provide a stronger attachment to the device have been developed.

An action mount typically connects to a protective case within which the mobile device is received. However, in most examples, the protective case is thicker than a conventional case and may be uncomfortable to hold when not connected to the action mount, the action mount is large and obtrusive, and the means by which the action mount and protective case are connected is complex and requires substantial effort from the user to operate. In examples where thin cases and small mounts are achieved, stability and vibration become issues because the connection between the case and mount is either not strong enough or insufficiently limits movement between the case and the mount.

### SUMMARY

There is a need for a means of attaching a mobile device to another object that addresses the above considerations. Specifically, there is a need for a case that is not excessively thick and that is also comfortable to hold and easy to use when disconnected from the mount. There is also a need for a mount that connects securely and stably to the case and that does not vibrate during use. Embodiments of the invention may address these and other problems, individually or collectively.

According to an aspect of the present invention, there is provided a mount for attaching a case of a mobile device to an object, the mount comprising a first coupling member and a second coupling member for attaching the mount to the case, and a body having a front face. The front face is arranged between the first and second coupling members and is arranged to face the case when the mount is attached to the case. The first and second coupling members each comprise a support that protrudes from the front face and an overhang that extends from the support. The support and the overhang together define an undercut for receiving part of the case.

A mount of this arrangement advantageously results in a secure connection between the case and the mount while enabling a slim case to be used. The secure connection is achieved by the undercut defined by both coupling members, which together receive parts of the case. The undercuts reduce movement of the case away from the mount as well as across the mount. The protrusion of the coupling members from the front face enables a slim case as well as an unobtrusive mount. This effectively focusses how the connection is formed between the case and mount.

The front face is arranged between the first and second coupling members. This may mean that the first and second coupling members are arranged on opposite sides of the front face. The first and second coupling members may be arranged symmetrically on opposite sides of the front face. This advantageously provides stability to the case when attached to the mount, helping to reduce vibration of the case.

In some embodiments, the overhangs of the first and second coupling members may extend from the respective supports in different directions. For example, the overhangs may extend towards one another, so that the coupling members may be considered to be facing one another. In other examples, the overhangs may extend away from one another, so that the coupling members may be perceived as facing away from one another. Either of these arrangements further improves the stability of the case when it is connected to the mount as well as improving the connection between the case and the mount.

The first coupling member may be moveable relative to the front face. In some embodiments, the mount comprises a first mechanism for moving the first coupling member relative to the front face. A moveable first coupling member may enable the mount to be connected to and disconnected from the case more easily. A mechanism enables the movement of the coupling member to be controlled, typically by a user.

The first coupling member may be rotatable relative to the front face about an axis between a first position for locking the mount to the part of the case and a second position for unlocking the mount from the part of the case. The first coupling member may be rotatable towards the front face when rotating from the first position to the second position. This may cause the position of the first coupling member, and, therefore, of the undercut, to be closer to the front face in the second position when compared to the first position. Rotating the first coupling member relative to the front face to provide locking of the mount to the case, as opposed to translating the first coupling member, allows for a more straightforward method of attachment. Rotation is useful because the case and mount are typically attached by bringing the case towards the mount perpendicular to the front face. By allowing the first coupling member to rotate relative to and towards the front face to adopt the second position, the case can effect this movement by creating a moment on the first coupling member. Rotating the first coupling member also changes the location of the undercut, allowing the case to be received within the undercut more easily. Moreover, the effective width of the overhang is reduced, enabling it to fit through a smaller opening in the case, and allowing for the case to have a reduced opening size. Such a reduced opening size reduces the likelihood of the first coupling member disconnecting from the case due to the case and mount moving relative to one another, and can reduce the ingress of dirt through the opening.

In the first position, the support may be perpendicular or substantially perpendicular to the front face. In the second position, the support may be angled relative to the front face. In the second position, the support may be angled towards the second coupling member, or closer to the second coupling member than when in the first position. In some embodiments, the support may extend through an aperture in the body. The axis about which the coupling member is rotatable may be positioned within the body, on an opposite side of the front face to the overhang. The axis may be offset relative to the overhang and the support, such that a moment is created when a force is applied to the overhang in the direction of the front face. Rotational movement is useful for these features also, enabling a smaller aperture in the body compared to a translatable coupling member.

The first coupling member may be chamfered. An outer edge of a region of the first coupling member at which the overhang and support meet may be chamfered. Chamfering this region of the first coupling member reduces the profile of the first coupling member when it is rotated to the second position, allowing it to fit through a smaller hole in the case. Furthermore, where the first coupling member extends through an aperture in the front face, the chamfer enables this aperture to be smaller also. The second coupling member may be chamfered in a similar way. The surfaces and edges of the support of the first and/or second coupling member may be straight to avoid the support from interfering with the case when received in the undercut.

The first mechanism may comprise a first user-actuable button that is actuable in a direction perpendicular to the axis to cause rotation of the first coupling member about the axis from the first position to the second position. The provision of a button may enable the user to control the movement of the first coupling member more precisely. This may allow the mount to be disconnected from the case more quickly. Configuring the button to actuate in the direction perpendicular to the axis results in a straightforward mechanism in which energy applied to the button may be applied to the first coupling member without a change in direction. In other words, the direction in which a force is applied to the user-actuable button is the direction in which the first coupling member moves, meaning firstly that the mechanism does not rely on complex internal workings to enable a change in the direction of the force, and secondly, that there is no energy lost due to changes in the direction of the force. Avoiding the need for such complex internal workings also allows the mount to be thinner.

The first user-actuable button may be configured to apply a force directly to the first coupling member. The first coupling member may have at least one force receiver to which the first user-actuable button is configured to apply the force when actuated. The part of the user-actuable button that applies the force may be called an outer force applicator. The force receiver may extend parallel to the axis of the first coupling member. Accordingly, when the first user-actuable button is actuated towards the force receiver, the outer force applicator may apply a force to the force receiver that causes the first coupling member to rotate about the axis from the first position to the second position. A force receiver and the direct application of force by actuating the user-actuable button further improves the straightforward nature of the mechanism. This is important not only for case of disconnection but also to reduce the chances of the mechanism malfunctioning. Extreme sports may involve water and dirt being splashed onto the mobile device, case, or mount, and some of the water and dirt may find its way into the mount.

A portion of the user-actuable button to which the user applies force to actuate the button may have a dimension that is larger than the same dimension of another portion of the user-actuable button, such as the outer force applicator. This provides a greater surface area for the user to press.

Optionally, the first mechanism comprises at least one first biasing element for urging the first user-actuable button to a natural position relative to the body. In the natural position the first user-actuable button and the first coupling member may be separated by a gap. Incorporating a gap between the user-actuable button in the natural position and the first coupling member allows incidental movement of the user-actuable button without actuating the first coupling member. In order to rotate the first coupling member, the user-actuable button has to be moved through the gap first before coming into contact with the first coupling member. This results in a button that has to be positively actuated by the user, and ensures that the mount does not disconnect accidentally during use.

The first biasing element may comprise at least one spring connected to the first user-actuable button at one end of the spring. Another end of the at least one spring may be connected to the body. Alternatively, the other end of the at least one spring may be connected to a second user-actuable button of the mount, the second user-actuable button being for moving the second coupling member.

The first mechanism may comprise an inner force applicator that applies a force directly to the first coupling member. The inner force applicator may apply a force to the at least one force receiver of the first coupling member. The inner force applicator may apply a force to the first coupling member to move it from the second position to the first position. The inner force applicator may be biased by the first biasing element or another biasing element to apply the force to the first coupling member. The first user-actuable button may comprise a cartridge configured to move within the body of the mount, the cartridge comprising the outer and inner force applicators and a portion that connects to the first biasing element.

An inner force applicator enables the first coupling member to be biased towards its first position to lock the case to the mount and limit movement of the first coupling member unless a force is positively applied to the user-actuable button. Accordingly, the case and mount won't disconnect without the user specifically applying a force to the button to unlock them.

The second coupling member may be moveable relative to the front face. This is useful in enabling even faster connection and disconnection of the case and the mount.

In some embodiments, the mount comprises a second mechanism for moving the second coupling member relative to the front face. The second mechanism may be independent from the first mechanism. Having a separate first and second mechanism to move the first and second coupling members respectively, as opposed to a single mechanism that moves both coupling members together, reduces the possibility of accidental disconnection of the mount from the case.

The second coupling member may be rotatable relative to the front face about an axis between a third position for locking the mount to the part of the case and a fourth position for unlocking the mount from the part of the case.

The second mechanism may comprise a second user-actuable button that is actuable in a direction perpendicular to the axis to cause rotation of the second coupling member about the axis from the third position to the fourth position. A second button and second mechanism together, as opposed to two buttons controlling a single mechanism, requires both buttons to be actuated to release the case from the mount. This is both easier for the user, enabling a gripping or pincer motion of the hand to be used to actuate both buttons, whilst also reducing the likelihood of disconnection if one button is pressed accidentally.

Optionally, the second mechanism comprises a second biasing element for urging the second user-actuable button to a natural position. In the natural position the second user-actuable button and the second coupling member may be separated by a gap.

The second mechanism may have some or all of the same features as the first mechanism.

In some embodiments, the mount comprises at least one positioning member for positioning the mount relative to the case. A positioning member may be configured to mate with an opening in the case, and so may perform the function of guiding the mount relative to the case as the two are introduced to each other. When the user is attempting to join the case to the mount, the positioning member(s) may usefully guide the case towards the correct position for engaging the coupling members. Furthermore, when the mount is connected to the case, the positioning member(s) may also position the case relative to the mount, to reduce relative movement between the case and the mount, because relative movement may cause wear-and-tear on other parts of the mount and case that interact.

The at least one positioning member may protrude from the front face. The at least one positioning member may be fixed relative to the front face. The at least one positioning member may be spaced apart from each of the first and second coupling members by a respective region of the front face. Spacing the positioning member(s) apart from coupling members on the front face allows the coupling members and positioning member(s) to each perform their functions without interacting with each other and without compromising each other's operation. Furthermore, this also allows for a thinner case to be used, because the members are separated and can be accommodated by the case separately. In other words, because the functions of each of the coupling members and positioning member(s) are performed at separate positions, due to the spacing of these members, the case does not need to be thickened in specific areas to account for this.

The at least one positioning member optionally comprises two positioning members. Two positioning members provides better positioning and greater stability to the mount than if only one positioning member were provided.

Where there are two positioning members, the first and second coupling members may be spaced apart in a first direction, and the positioning members may be spaced apart in a second direction that is perpendicular to the first direction. The two positioning members may lie along a centreline of the mount. The first and second coupling members may be arranged symmetrically about the centreline of the mount. Arranging the positioning members in this way provides stability to the mount. Alternatively, the first and second coupling members may be arranged along a first diagonal to the centreline, while the two positioning members may be arranged along a second diagonal to the centreline that is perpendicular to the first diagonal.

The at least one positioning member may protrude further from the front face than the first and second coupling members. By protruding further from the front face than the coupling members, the at least one positioning member may perform any or all of three functions. Firstly, the positioning member(s) may form the uppermost part of the mount when the case is brought towards the mount, so that the positioning member(s) interacts with the case first, providing a positioning function before the case interacts with the coupling members. This ensures that the openings in the case and the coupling members are roughly aligned by the action of the positioning member(s) before the case and coupling members come into contact with one another. This may reduce wear and tear caused by excessive relative movement between the coupling members and the case. Secondly, the at least one positioning member may space the coupling members from the rear of the mobile device and/or an internal face of the case, which is useful in reducing wear. Particularly where the openings in the case are through-holes, this is important in reducing scratches to the device from the coupling members, which may be formed of a harder material than the positioning member(s). Thirdly, the positioning member(s) may act to encourage engagement between the case and the coupling members to reduce relative movement. In other words, because the positioning member(s) may effectively reduce movement of the mount too far towards the case by interacting with the rear of the device, the coupling members and case are kept in close proximity.

The at least one positioning member may be integrally formed with the front face. The at least one positioning member may be formed from a more flexible material than the first and second coupling members. The first and second coupling members may be formed of metal. The metal may comprise aluminium or an aluminium compound. Alternatively, the metal may comprise steel.

The at least one positioning member may be dimensioned such that a longest dimension of the at least one positioning member is greater than a longest dimension of the first and second coupling members. The longest dimension of the at least one positioning member may be perpendicular to the longest dimension of the first and second coupling members. The longest dimensions of the at least one positioning member and/or the first and second coupling members may be perpendicular to the direction in which the at least one positioning member and/or the first and second coupling members protrude. The dimensions of the at least one positioning member may be determined to have a smaller clearance with a through-hole of the case then the first and second coupling members.

Additionally, or as an alternative to the at least one positioning member, the mount may comprise one or more further coupling members. The one or more further coupling members may have the same features as the first and second coupling members. The mount may comprise one or more further mechanisms for controlling the one or more further coupling members. The one or more further coupling members may be controlled by the first and/or second mechanisms.

In some embodiments, the one or more further coupling members may comprise a third coupling member and a fourth coupling member. In these embodiments, the first and second coupling members may be spaced apart in a first direction, and the third and fourth coupling members may be spaced apart in a second direction that is perpendicular to the first direction. The third and fourth coupling members may lie along a centreline of the mount, while the first and second coupling members may be arranged symmetrically about the centreline of the mount. In some such embodiments, the at least one positioning member may also be provided. In other such embodiments, the at least one positioning member may not be provided.

In some embodiments, the mount comprises a resilient element that is configured to urge the case towards the overhang of one or both of the first coupling member and the second coupling member when the respective parts of the case are received in the respective undercuts. By urging the case towards the overhang, the resilient element strengthens the connection between the mount and the case. This is because by urging the case and overhang together, the distance between the case and overhang can be reduced, which makes relative movement of the case and overhang more difficult.

Reducing relative movement reduces vibration of the case and mount in use. Vibration may cause unwanted ‘rattle’ of the case on the mount, by the case flexing or moving relative to the mount and causing wear on the coupling members. This is reduced by urging the mount and case together using the resilient element.

In particular embodiments, in which the first coupling member rotates between a first and a second position to lock and unlock from the case, the resilient element allows for the case to be urged towards the first coupling member when it is in the first position, thereby improving how the two are locked together. Because the first coupling element rotates towards the front face to the second position to unlock, the case being closer to the overhang restricts how the first coupling member moves. However, the first coupling member is not prevented from rotating because the resilient element is able to compress or move to allow the case to be unlocked.

The resilient element may comprise a resilient loop that surrounds the first and second coupling members. The resilient element may be configured to form a seal with the case. The resilient element may be formed of a thermoplastic elastomer material. Where the mount comprises one or more positioning members, the resilient loop may surround the one or more positioning members.

A surface of the overhang of each of the first and second coupling members may be inclined relative to the front face. The surface of the overhang may be inclined at an angle of more than 0 degrees and less than or equal to 45 degrees relative to the front face. The surface of the overhang may be inclined so that it is tangential or substantially tangential to the arc of its rotation about the axis. An inclined overhang, and particularly an overhang inclined to an angle in the range described, provides optimized locking of the first coupling member with respect to the case. The angle of the surface of the overhang is important to securely lock the case and mount together. If the overhang were substantially parallel with the front face, the undercut of the mount would need to be large in order to allow the overhang to rotate from the second to the first position and lock the case in place without scraping or otherwise interfering with the case during the rotation. If the angle of inclination of the surface of the overhang were too great, then the depth of the case would need to be increased to accommodate the coupling members, and the connection formed between the mount and the case would lack the strength required for using the mount in sporting activities.

The inclined overhang is also useful in combination with the resilient element, because the resilient element allows the case to move towards the mount sufficiently to allow rotation of the first coupling member into the first position without interference, and subsequently urges the case and mount together to effectively lock the two together. The combination of the resilient element, inclined overhang, rotation of the first coupling member at least about an axis, and the first mechanism comprising a user-actuable button together result in a particularly strong connection between the mount and the case that is unlikely to accidentally disconnect.

In some embodiments, the mount comprises a magnetic coupling element that is separate from the first and second coupling members. The magnetic coupling element may comprise a plurality of magnets arranged in a multipole array such as a Halbach array. The magnetic coupling elements may be arranged to couple with corresponding magnetic coupling elements in the case.

In some embodiments, the mount comprises at least one structure for connecting the mount to the object. The structure may be connected to the body of the mount by a connector. The connector may comprise a screw. The structure may comprise a bike mount. The structure may comprise a clamp. The structure may comprise an arm configured to connect to the object. The structure may be configured to connect the mount to at least one of apparatus such as a surf-, skate- or snowboard or bicycle or motorcycle handlebars, clothing such as a helmet or harness, or to a part of a user's body.

According to another aspect of the present invention, there is provided a mount for attaching a case of a mobile device to an object. The mount comprises a first coupling member and a second coupling member for attaching the mount to the case. The mount also comprises a body having a front face. The front face is arranged between the first and second coupling members and is arranged to face the case when the mount is attached to the case. The mount of this aspect may have some or all of the features of the mount described above.

According to another aspect of the present invention, there is provided a case for attaching a mobile device to a mount as described above.

According to a further aspect of the present invention, there is provided a case for attaching a mobile device to a mount. The case comprises an attachment for attaching the case to the mobile device. The case comprises a cover. The cover has an inner surface arranged to face the mobile device when the case is attached to the mobile device and an outer surface arranged to face a front face of the mount when the mount is attached to the case. The case comprises a first opening in the cover and a second opening in the cover. The case comprises a first overhang and a second overhang. The first overhang and second overhang define first and second undercuts in respective side walls of the first and second openings for mating with corresponding respective overhangs of first and second coupling members of the mount.

Advantageously, a case having at least two openings and at least two overhangs defining undercuts for mating with the mount provides a stable and secure attachment, while enabling the case to avoid excessive thickness where it connects to the mount. Particularly, because multiple openings and overhangs are provided, the way in which the case enables attachment is focussed to specific areas of the case, avoiding large parts of the case being dedicated to mounting. This avoids configurations on the rear of the case that make it difficult to hold and that require excess thickness. Furthermore, the use of undercuts within openings rather than features that protrude from or extend beyond the case enables the reduced thickness. One or each of the first and second openings may be through-holes. One or each of the first and second openings may be blind holes.

The first overhang and second overhang may be integrally formed in the cover. Integral overhangs reduce the complexity of manufacturing the cover, whilst also improving its strength. Integral overhangs also allow for the overhangs and undercuts to be small, because of the case with which they can be manufactured, and so avoid unnecessary thickness being added to the case.

A surface of the overhang that faces the rear of the mobile device when the case is attached to the mobile device may be inclined relative to an outer surface of the case. The incline may be substantially similar to an incline of a corresponding overhang of the mount. The incline may be more than 0 and less than or equal to 45 degrees. A surface of the overhang that faces away from the rear of the mobile device when the case is attached to the mobile device may be flush with a rear surface of the case. This creates a reduced thickness of the case.

The first and second openings may be positioned symmetrically about a centreline of the cover.

In some embodiments, the case comprises a third opening in the cover and a fourth opening in the cover. The third and fourth openings may be for receiving respective positioning members of the mount for positioning the mount relative to the case. Where the case comprises a third opening and a fourth opening, the first and second openings may be spaced apart in a first direction, and the third and fourth openings may be spaced apart in a second direction that is perpendicular to the first direction. One or each of the third and fourth openings may be through-holes. One or each of the third and fourth openings may be blind holes. The third and fourth openings may lie along a centreline of the cover. The third and fourth openings may be arranged along a first diagonal to the centreline, and the first and second openings may be arranged along a second diagonal to the centreline that is perpendicular to the first diagonal.

The third and fourth openings may be configured to receive one or more positioning members. Alternatively or additionally, the third and fourth openings may be configured to receive the first and second coupling members of the mount and/or one or more further coupling members of the mount. The first, second, third, and fourth openings may be configured to receive a coupling member or a positioning member. Each of the first, second, third, and fourth openings may have a substantially similar set of dimensions.

The cover of the case may comprise a plate that defines an outer surface of the cover and a silicon layer that defines the inner surface of the cover. The silicon layer may provide cushioning on the rear of the mobile device. The silicon layer may create a seal with the rear of the mobile device when the case is attached to the mobile device in order to limit water or dirt from travelling across the rear of the mobile device and causing damage to it. The plate may be formed of a thermoplastic, such as polycarbonate.

One or more magnetic elements may be incorporated into the cover between the inner and outer surfaces. The one or more magnetic elements may be received in a corresponding groove in the plate. The one or more magnetic elements may be covered by a stiffener.

The first and second openings may be chamfered where the openings meet the outer surface. The first and second openings may be chamfered to match a chamfer provided on coupling members of the mount.

The attachment of the case and the cover of the case may be integrally formed.

According to a further aspect of the present invention, there is provided a case for attaching a mobile device to a mount. The case comprises an attachment for attaching the case to the mobile device. The case comprises a cover. The cover has an inner surface arranged to face the mobile device when the case is attached to the mobile device and an outer surface arranged to face a front face of the mount when the mount is attached to the case. The case comprises a first opening in the cover, a second opening in the cover, a third opening in the cover, and a fourth opening in the cover. The first and second openings are spaced apart in a first direction, and the third and fourth openings are spaced apart in a second direction that is perpendicular to the first direction.

The case may comprise a first overhang and a second overhang. The first overhang and second overhang may define first and second undercuts in respective side walls of the first and second openings for mating with corresponding respective overhangs of the mount.

According to a further aspect of the present invention, there is provided a mount for connecting to a case as described above.

According to a further aspect of the present invention, there is provided a kit of parts comprising a mount as described above and a case as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIGS. 1A and 1B show a case and a mount for attaching a mobile device to an object in an unconnected configuration and a connected configuration respectively according to an embodiment of the invention.

FIG. 2 shows a top view of a case according to an embodiment of the invention.

FIG. 3 shows a sectional view of the case of FIG. 2 along the line A-A.

FIG. 4 shows an exploded view of the case of FIG. 2.

FIG. 5 shows a perspective view of a mount according to an embodiment of the invention.

FIG. 6 shows a top view of the mount of FIG. 5 in which an interior of the mount is visible.

FIGS. 7A to 7D illustrate a process of attaching the mount to the case through a series of side views.

FIG. 8 illustrates how the mount may be unattached from the case through a side view.

### DETAILED DESCRIPTION

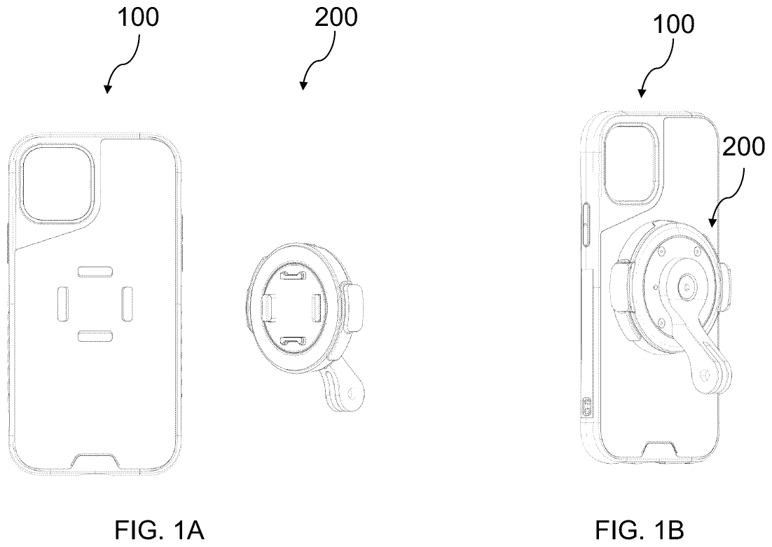

A case 100 and a mount 200 for a mobile device are shown in FIGS. 1A and 1B. The case 100 is configured to attach to a mobile device (not shown). The mount 200 is configured to attach to the case 100 and to a further object (not shown). The case 100 and mount 200 are therefore configured to attach a mobile device to a further object. The case 100 and mount 200 are shown separately in FIG. 1A, and can therefore be said to be in an unconnected configuration. In FIG. 1B, the case 100 and mount 200 are attached to one another and are therefore in a connected configuration.

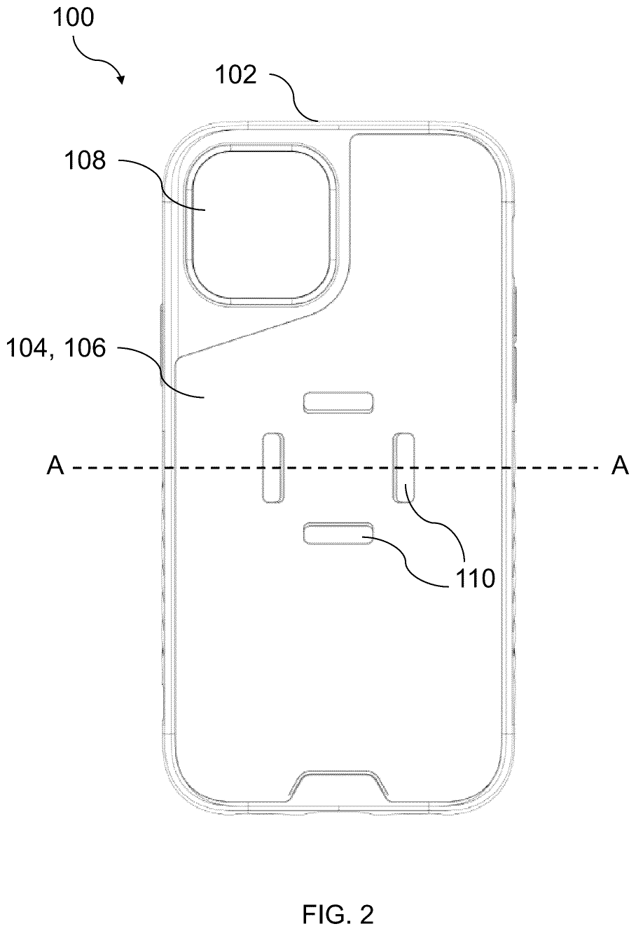

FIG. 2 shows a top view of the case 100. The case 100 includes an attachment 102. The attachment 102 comprises a bumper that surrounds the edges of the mobile device and holds the mobile device within the case 100 in use. The case 100 comprises a cover 104 that covers a rear surface of the mobile device in use. The cover 104 and attachment 102 are arranged such that the attachment 102 extends from edges of the cover 104. The attachment 102 is integral with the cover 104.

The cover 104 may be formed of a material such as a thermoplastic. For example, the cover may be formed of polycarbonate. The attachment 102 may also be formed of the material that forms the cover and/or may incorporate shock-absorbing or resilient material. The cover 104 and attachment 102 may protect the mobile device from being dropped or from other impacts that may cause damage to the mobile device.

The cover 104 has an inner surface (not visible in FIG. 2) arranged to face the mobile device (not shown) when the case 100 is attached to the mobile device. The cover 104 has an outer surface 106. The outer surface 106 faces away from the mobile device when the case 100 is attached to the mobile device. The outer surface 106 is arranged to face a front face of the mount 200 when the mount 200 is attached to the case 100. This is described in more detail below.

The cover 104 includes a window 108. The window 108 is for allowing one or more camera lenses of the device or other camera accessories to be uncovered by the case 100.

In other embodiments, the case may include additional windows to allow other features of the mobile device to be accessible through the case. For example, a window may be provided to provide access to one or more buttons, one or more fingerprint sensors, or to ensure that one or more audio components are uncovered.

The case 100 incorporates four openings 110 in the cover 104. In the embodiment of FIG. 2, the openings are through-holes. The openings 110 are configured to mate with features of the mount 200 configured to couple the case 100 and mount 200 together or to position the mount 200 relative to the case 100.

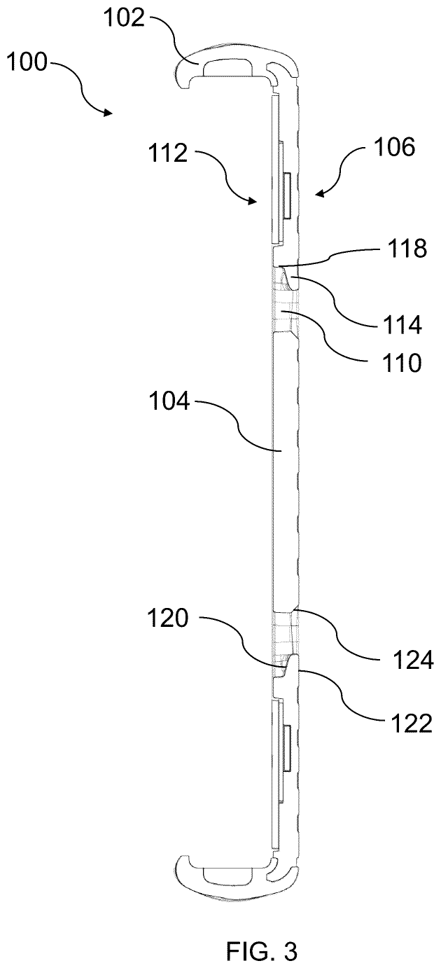

FIG. 3 shows a side section of the case along the line A-A. In FIG. 3, the attachment 102 is shown on either side of the cover 104. The inner surface 112 of the cover 104 and the outer surface 106 are both shown in FIG. 3.

As can also be seen in this Figure, the case comprises an overhang 114 in each opening 110. An overhang 114 is provided in each opening 110 so that the mount can be connected to the case in at least two orientations. Each overhang 114 defines an undercut 116 in a side wall 118 of its opening 110. The overhang 114 is for mating with corresponding respective overhangs of the mount 200, as will be described below. Although only two openings 110 and corresponding overhangs 114 are shown here, by virtue of FIG. 3 depicting a side view, it will be appreciated that an overhang 114 is also provided in each of the openings 110 that are not visible in this view.

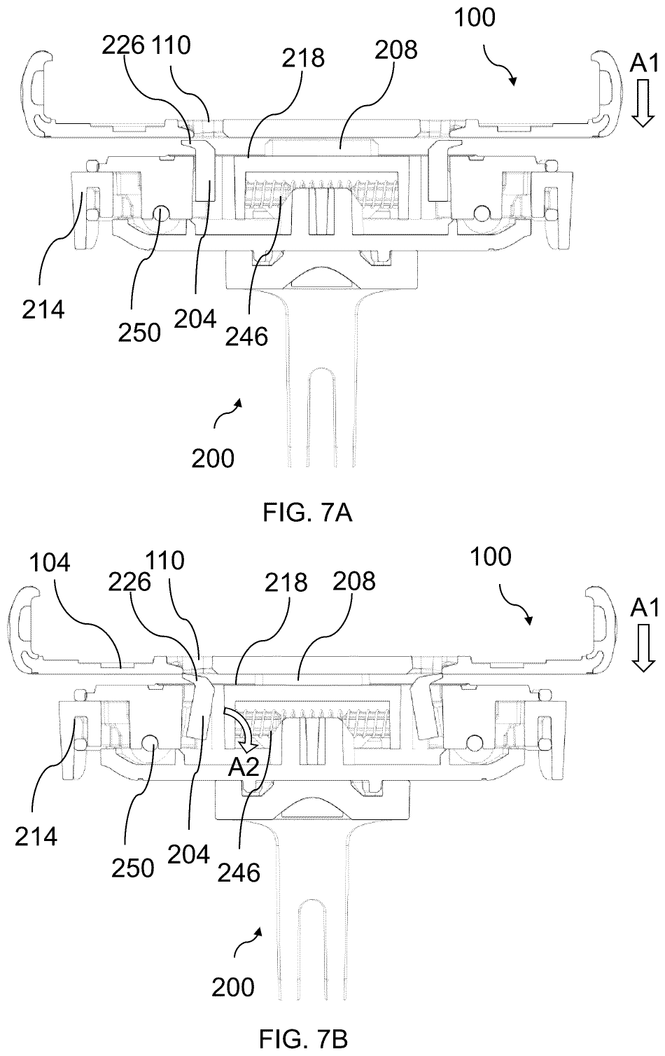

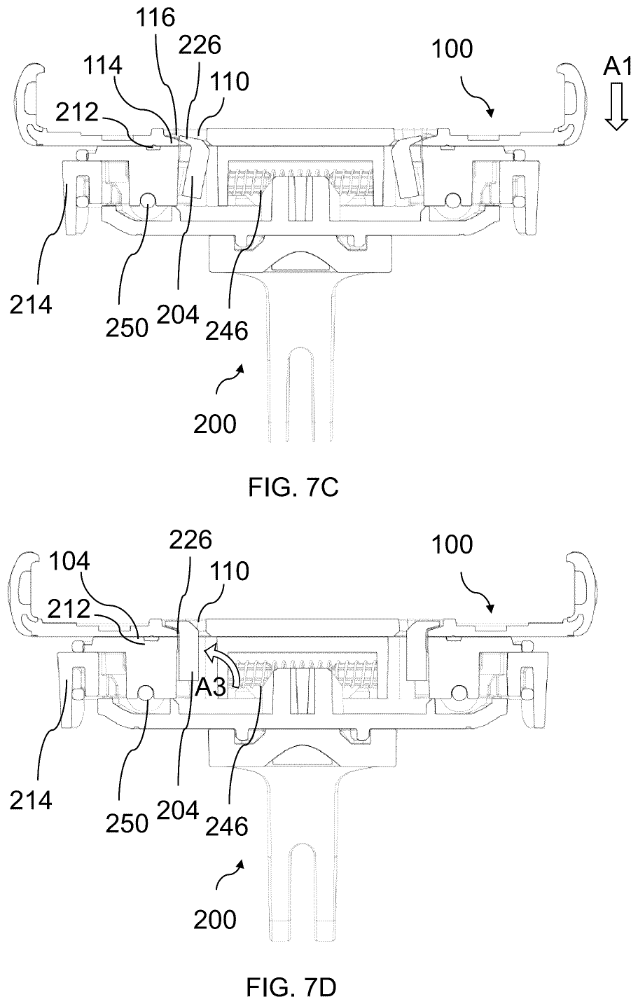

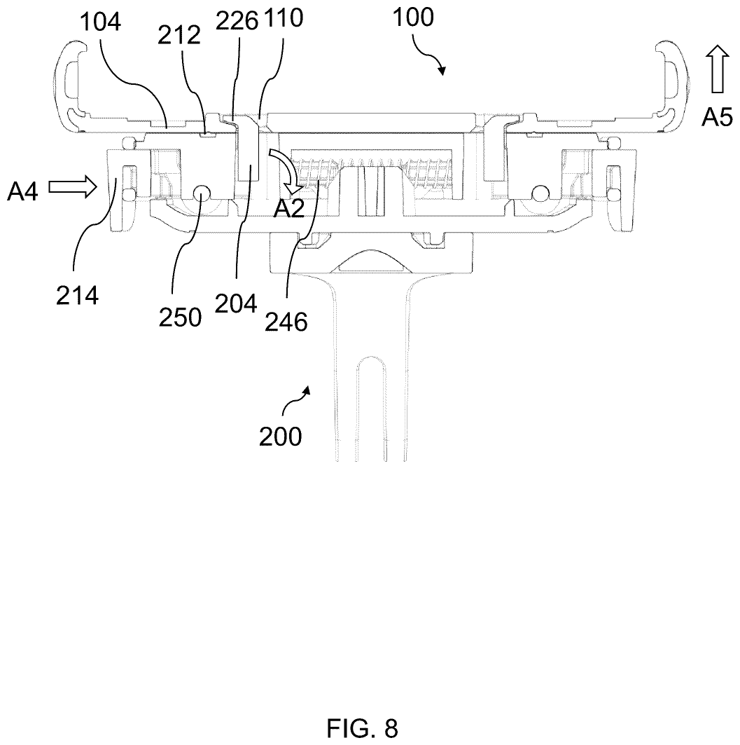

The overhang 114 in each opening 110 and the openings 110 themselves, as will be explained in relation to FIGS. 7A to 7D and 8, are configured for mating with coupling members of the mount 200 and to enable connection of the mount 200 and the case 100 together. In FIG. 3, it can be seen that an inner surface 120 of each overhang 114 that faces the mobile device in use is inclined relative to the inner and outer faces 112, 106. An opposing surface of the overhang, outer surface 122, is flush with the outer face 106 of the cover 104.

The edges 124 in the region at which the openings 110 and the outer face 106 meet are chamfered.

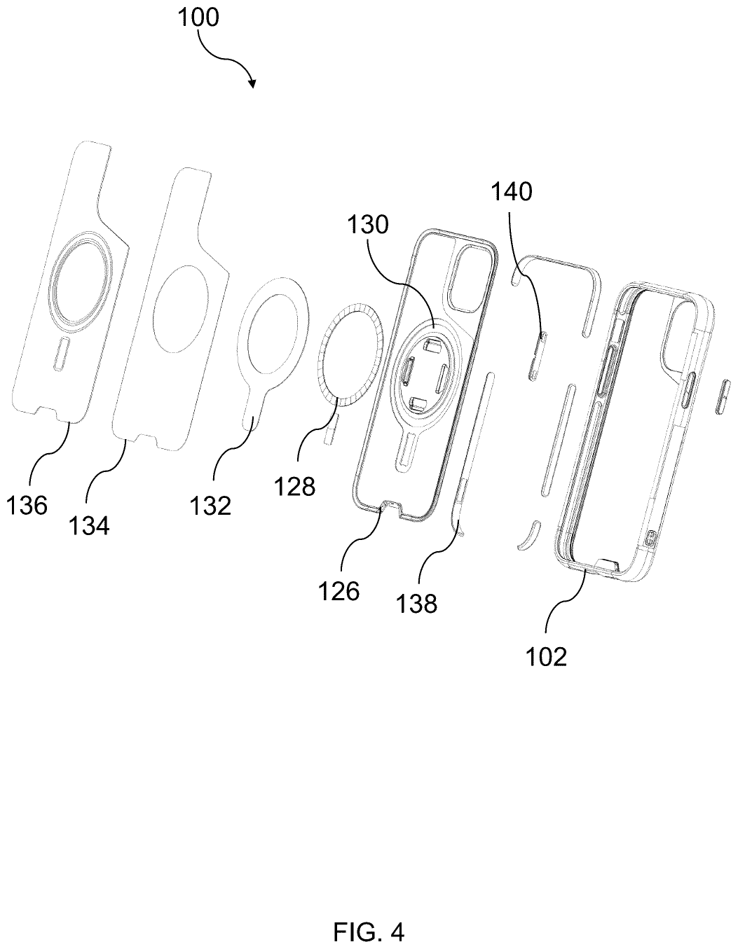

FIG. 4 shows an exploded view of the case. The case includes the attachment 102 in the form of a bumper, and the cover 104. The cover comprises a plate 126, a ring of magnets 128 that are received in a corresponding groove 130 in the plate 126, a stiffener 132 that covers the magnets 128, an adhesive layer 134 and a silicon layer 136 that attaches to the adhesive 134 and defines the inner face 112 of the cover 104. Also depicted are a shock-absorbing layer 138 and a pair of buttons 140.

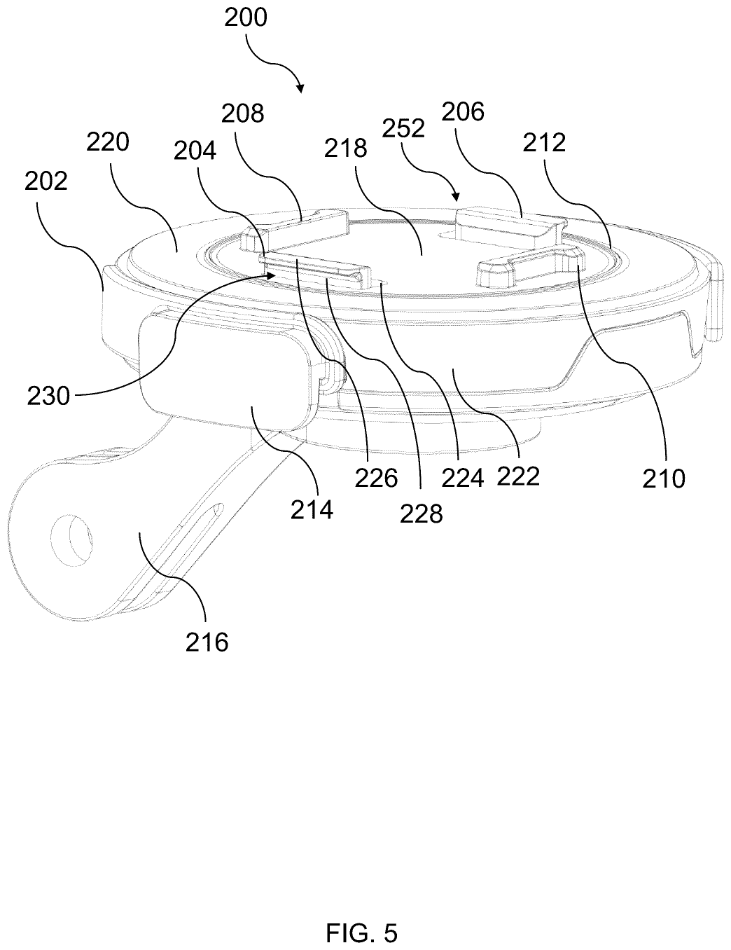

The mount 200 is depicted in FIG. 5 in a perspective view. The mount 200 includes a body 202, a first coupling member 204, a second coupling member 206, a first positioning member 208, a second positioning member 210, a resilient element 212, two user-actuable buttons 214 for actuating the first and second coupling members 204, 206 respectively, only a first of the buttons being visible in this figure, and a structure 216 for connecting the mount 200 to a further object (not shown).

The body 202 has a front face 218 that is arranged between the first and second coupling members 204, 206 and between the first and second positioning members 208, 210. The front face 218 may be considered to define a square having sides along which the coupling and positioning members 204, 206, 208, 210 sit. Alternatively, the front face 218 may be considered to define a circle that connects each of the coupling and positioning members 204, 206, 208, 210.

The body 202 also has a surrounding face 220 that surrounds the front face 218 as well as the first and second coupling members 204, 206, and the first and second positioning members 208, 210. The surrounding face 220 has a circular perimeter. The surrounding and front faces 220, 218 together define an upper face of the mount 200.

The body 202 also includes a cylindrical side wall 222 extending from the surrounding face 220. The upper face of the mount covers one end of the side wall 222. The first user-actuable button 214 and second user-actuable button (not visible in FIG. 5) extend through the side wall 222 to connect to respective first and second mechanisms (not visible in FIG. 5) that are provided within an interior volume defined by the body 202. A rear face (not visible in FIG. 5) of the body 202 is provided that covers the opposite end of the side wall 222 to the upper face. The structure 216 for connecting the mount 200 to the further object is attached to the mount 200 at the rear face.

The first coupling member 204 and the second coupling member 206 protrude from the body 202 and above the front face 218. The first and second coupling members 204, 206 extend through respective apertures 224 in the body 202. The coupling members 204, 206, each have an overhang 226 and a support 228. The supports 228 extends through the apertures 224 to protrude from the front face 218. The overhang 226 of each member 204, 206 extends from the support 228. The support 228 and the overhang 226 of each member 204, 206 together define an undercut 230, for receiving part of the case 100. Specifically, the undercut 230 is configured to receive a corresponding overhang 114 of the case 100. The first and second coupling members 204, 206 are chamfered at a region 252 in which the overhang and support meet.

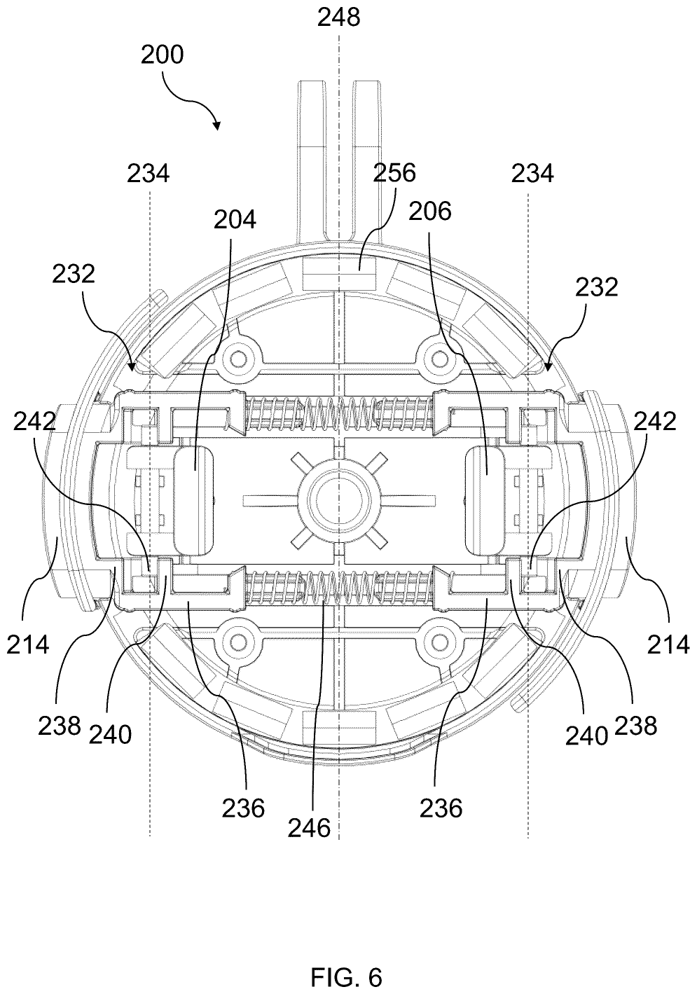

The first coupling member 204 and second coupling member 206 are configured to rotate relative to the front face 218. This is achieved using an interior mechanism of the mount 200, which is described below in relation to FIGS. 6 to 8.

The first and second coupling members 204, 206 are formed from aluminium.

The first and second positioning members 208, 210 are integrally formed with at least a part of the body. The first and second positioning members 208, 210 protrude from the front face 218 and are separate from each other and from the first and second coupling members 204, 206 by parts of the front face 218. The first and second positioning members 208, 210 extend further from the front face 218 than the first and second coupling members 204, 206.

The first and second positioning members 208, 210, and at least the part of the body with which they are integral, are formed of a thermoplastic material.

The first and second coupling members 204, 206 are symmetrical about a centreline 248 (indicated with a dash-dot line in FIG. 6) of the mount and are spaced apart in a first direction, while the first and second positioning members 208, 210 are symmetrically arranged on the centreline and are spaced apart in a second direction, perpendicular to the first direction.

The resilient element 212 comprises a resilient loop that surrounds the first and second coupling members 204, 206, first and second positioning members 208, 210, and the front face 218. The resilient loop is positioned in a groove in the surrounding face 220 and has a ridge that protrudes above the front face 218. The resilient element 212 protrudes above the front face 218 less than the first and second coupling members 204, 206. The resilient element 212 is formed of a thermoplastic elastomer. The resilient element 212 compresses or otherwise deforms when the case 100 is pressed against it. The resilience of the resilient element 212 urges the case away from the front face 218 and towards the overhangs 226 when the case 100 is received in the undercuts 230. Urging the case away from the front face 218 by the resilient clement 212 improves the connection between the overhangs formed in the case 100 and the mount 200. The resilient element 212 being formed as a loop forms a barrier that may reduce ingress of dirt and water towards the coupling members 204, 206, positioning members 208, 210, and apertures 224.

The first and second coupling members 204 and 206 are moveable relative to the front face 218 by rotation about respective axes 234, which are indicated in FIG. 6 with dashed lines. The first and second coupling members 204 and 206 are moveable between a first position, which is shown in FIGS. 5 and 6, and a second position, which is shown in FIGS. 7C and 8. In the first position, the support 228 is perpendicular to the front face 218. In the second position, the support 228 is inclined relative to the front face 218. When the coupling members 204 and 206 are both in the second position, the supports are inclined towards one another.

The first and second coupling members 204, 206 are rotatable about the axes 234 by respective mechanisms 232. FIG. 6 shows the mount 200 displayed in a top view with the upper face and positioning members removed to allow the mechanism and other aspects of the interior of the body 202 to be shown.

Each of the first and second coupling members 204, 206 has a respective mechanism 232 for rotating the coupling member about its respective axis 234. The axes 234 are offset relative to the support 228 and overhang 226 (not visible in FIG. 6) of the respective coupling members 204, 206.

The mechanism 232 includes the user-actuable buttons 214. The user-actuable buttons 214 are actuable to rotate the coupling members 204, 206. Each user-actuable button 214 comprises a cartridge 236 that moves within the body 202.

The cartridge 236 moves perpendicularly to the axis 234 of each coupling member 204, 206. The cartridge 236 includes outer and inner force applicators 238, 240 that are configured to apply a force to the coupling member 204, 206 as the cartridge slides within the body 202. The force applicators 238, 240 apply a force to drive receivers of the coupling member 204, 206, in the form of protrusions 242 that extend parallel to the axis of the coupling member, relative to the body 202. The force applicators 238, 240 are positioned to either side of the protrusions 242 with respect to the direction in which the cartridge 236 slides, so that sliding the cartridge 236 inwards, towards a centre of the mount 200, causes the outer force applicators 238 to apply a force to the protrusions 242 and sliding the cartridge 236 outwards, away from the centre of the mount 200, causes the inner force applicators 240 to apply a force to the protrusions. By this sliding, the coupling member 204, 206 can be moved between the first position and the second position.

An end 244 of each cartridge 236 is connected to a pair of biasing elements, which in this embodiment is a pair of springs 246. Each end of a spring 246 is connected to a respective cartridge 236. The springs 246 bias the cartridge so that the inner force applicators 240 are pressed against the protrusions 242 to maintain the coupling members 204, 206 in the first position. In this position, the user-actuable button 214 is considered to be in a natural position relative to the body. To move the coupling members 204, 206 from the first position, the user-actuable button 214 is pressed against the action of the springs 246 to move the outer force applicators towards and into contact with the protrusions 242. A space is provided between the force applicators 238, 240 that is wider than the size of the protrusions 242. This forms a gap between the outer force applicators 238 of the user-actuable button 214 and the protrusions 242 of one of the coupling member 204, 206 when the user-actuable button 214 is in its natural position, so that when the user-actuable button 214 is pressed, the outer force applicators 238 have to travel the distance of the gap before coming into contact with the protrusions 242.

Also visible in FIG. 6 are magnetic elements 256 that are arranged around parts of the circumference of the body 202 that are not occupied by the cartridge 236. The magnetic elements 256 are arranged to couple with corresponding magnetic elements in the case 100.

FIGS. 7A to 7D show a process of attaching the case and mount together, including how the coupling members 204, 206 move relative to the case. FIG. 8 shows a process of detaching the case from the mount. FIGS. 7A to 7D and 8 are cutaway side views of the case and mount. For case of description, the actions in FIGS. 7A to 7D and 8 are described in relation to the first coupling member 204 and its mechanism 232. These actions are also performed by the second coupling member 206 and its mechanism 232 to achieve connection of the case and mount in FIGS. 7A to 7D and disconnection in FIG. 8.

As shown in FIG. 7A, the case 100 is brought towards the mount 200, in the direction indicated by the arrow A1. The case 100 and mount 200 are brought together so that the outer face 106 of the case 100 and the front face 218 of the mount 200 face each other and are substantially parallel to one another. The opening 110 is roughly aligned with the coupling member 204.

As shown in FIG. 7B, when the case 100 comes into contact with the coupling member 204, a moment is created about the axis 234 of the coupling member 204. The moment causes the coupling member 204 to rotate about the axis 234 in the direction indicated by arrow A2. The coupling member 204 rotates from the first position shown in FIG. 7A to the second position shown in FIG. 7C.

The movement of the coupling member 204 is caused by the case 100 pressing on the overhang of the coupling member 204. The coupling member 204 is therefore moved against the action of the springs 246 and without a user actuating the user-actuable button 214.

In FIG. 7B, if the coupling member 204 and opening 110 are not aligned, the user may move the case 100 relative to the mount 200 to attempt to align them. To aid with this alignment, the positioning members 208, 210 are provided (only one positioning member 208 is visible in FIGS. 7A to 7D). The positioning members 208, 210 protrude further from the front face 218 than the coupling members 204, 206, so that they contact the case 100 before the coupling members 204, 206 contact the case 100. The positioning members 208, 210 therefore help position the mount 200 and case 100 relative to one another before force is applied to the coupling members 204, 206 by the case to rotate them. The magnetic elements 256 and magnet ring 128 may also help with alignment (the magnetic elements 256 and magnetic ring 128 are not visible in FIGS. 7A to 7D).

In FIG. 7C, the opening 110 and coupling member 204 align while the coupling member 204 is in the second position and the overhang 226 is able to pass through the opening 110. The chamfering on both the opening 110 and the coupling member 204 allow the coupling member 204 to pass through the opening 110 without interference with the case 100.

As the overhang 226 is received through the opening, the coupling member 204 is rotated back towards the first position by the springs 246 biasing the cartridge 236 to push against the coupling member 204. By this action the overhang 226 can move into the undercut 116 and the corresponding overhang 114 can move into the undercut 230. Due to the shape of the overhangs, the overhangs 114 and 226 may interfere if there is not a gap between the surfaces that face the undercut, so the case 100 is pressed further towards the mount 200, to compress or deform the resilient element 212 and allow a gap between the overhangs 114, 226.

Subsequently, as shown in FIG. 7D, the coupling member 204 moves back to its first position as indicated by the arrow A3 and the case 100 is pressed away from the mount 200 by the resilient element 212 to hold the case 100 and mount 200 in contact with each other, thereby locking the case 100 and mount 200 together.

As shown in FIG. 8, the case 100 and mount 200 may be unlocked by pressing the user-actuable button 214 towards the coupling member 204 in the direction indicated by arrow A4. This causes the coupling member 204 to rotate to its second position, by the action of the cartridge 236 and its force applicators 238 on the protrusions 242, in the direction of the arrow A2. Although not shown in FIG. 8, a corresponding operation occurs with the second coupling member 206. The rotation of the two coupling members 204, 206 allows the case 100 to be lifted away from the mount 200 in the direction of the arrow A5, thereby disconnecting the case 100 and mount 200. In order to allow a sufficient gap between the overhangs 114, 226, the case 100 may be pressed towards the mount 200 against the action of the resilient element 212 to allow rotation of the first coupling member 204.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A mount for attaching a case of a mobile device to an object, the mount comprising:
a first coupling member and a second coupling member for attaching the mount to the case; and
a body having a front face that is arranged between the first and second coupling members and that is arranged to face the case when the mount is attached to the case;
wherein the first and second coupling members each comprise a support that protrudes from the front face and an overhang that extends from the support, the support and the overhang together defining an undercut for receiving part of the case.

2. The mount of claim 1, wherein the first coupling member is moveable relative to the front face, and wherein the mount comprises a first mechanism for moving the first coupling member relative to the front face.

3. The mount of claim 2, wherein the first coupling member is rotatable relative to the front face about an axis between a first position for locking the mount to the part of the case and a second position for unlocking the mount from the part of the case, and wherein the first mechanism comprises a user-actuable button that is actuable in a direction perpendicular to the axis to cause rotation of the first coupling member about the axis from the first position to the second position.

4. The mount of claim 3, wherein the first mechanism comprises at least one biasing element for urging the user-actuable button to a natural position relative to the body, wherein in the natural position the button and the first coupling member are separated by a gap.

5. The mount of claim 2, wherein the second coupling member is moveable relative to the front face.

6. The mount of claim 1, comprising at least one positioning member for positioning the mount relative to the case, wherein the positioning member protrudes from and is fixed relative to the front face, and wherein the positioning member is spaced apart from each of the first and second coupling members by a respective region of the front face.

7. The mount of claim 6, wherein the at least one positioning member comprises two positioning members and wherein the first and second coupling members are spaced apart in a first direction, and the positioning members are spaced apart in a second direction that is perpendicular to the first direction.

8. The mount of claim 6, wherein the at least one positioning member protrudes further from the front face than the first and second coupling members.

9. The mount of claim 6, wherein the at least one positioning member is integrally formed with the front face.

10. The mount of claim 1, comprising a resilient element that is configured to urge the case towards the overhang of one or both of the first coupling member and the second coupling member when the respective parts of the case are received in the respective undercuts.

11. The mount of claim 10, wherein the resilient element comprises a resilient loop that surrounds the first and second coupling members.

12. The mount of claim 1, wherein a surface of the overhang of each of the first and second coupling members is inclined relative to the front face.

13. The mount of claim 12, wherein the surface of the overhang is inclined at an angle of more than 0 degrees and less than or equal to 45 degrees relative to the front face.

14. The mount of claim 1 comprising at least one structure for connecting the mount to the object.

15. A case for attaching a mobile device to a mount, the case comprising:
an attachment for attaching the case to the mobile device;
a cover having an inner surface arranged to face the mobile device when the case is attached to the mobile device and an outer surface arranged to face a front face of the mount when the mount is attached to the case;
a first opening in the cover and a second opening in the cover; and
a first overhang and a second overhang that define first and second undercuts in respective side walls of the first and second openings for mating with corresponding respective overhangs of first and second coupling members of the mount.

16. The case of claim 15, wherein the first overhang and second overhang are integrally formed in the cover.

17. The case of claim 15, wherein the first and second openings are positioned symmetrically about a centreline of the cover.

18. The case of claim 15 comprising a third opening in the cover and a fourth opening in the cover, the third and fourth openings for receiving respective positioning members of the mount for positioning the mount relative to the case.

19. The case of claim 18 wherein the first and second openings are spaced apart in a first direction, and the third and fourth openings are spaced apart in a second direction that is perpendicular to the first direction.

20. A kit of parts comprising:
a mount for attaching a case of a mobile device to an object; and
a first coupling member and a second coupling member for attaching the mount to the case; and
a body having a front face that is arranged between the first and second coupling members and that is arranged to face the case when the mount is attached to the case;
wherein the first and second coupling members each comprise a support that protrudes from the front face and an overhang that extends from the support, the support and the overhang together defining an undercut for receiving part of the case;
a case for attaching a mobile device to the mount, the case comprising:
an attachment for attaching the case to the mobile device;
a cover having an inner surface arranged to face the mobile device when the case is attached to the mobile device and an outer surface arranged to face a front face of the mount when the mount is attached to the case;
a first opening in the cover and a second opening in the cover; and
a first overhang and a second overhang that define first and second undercuts in respective side walls of the first and second openings for mating with corresponding respective overhangs of first and second coupling members of the mount.
